(19) United States
(12) Patent Application Publication
(10) Pub. No.: US 2018/0232123 A1
(43) Pub. Date: Aug. 16, 2018

(54) USER INPUT USING TOUCHSCREEN DISPLAY SUBAREAS

(71) Applicant: Fitbit, Inc., San Francisco, CA (US)

(72) Inventors: Michael Paul SPARANDARA, San Francisco, CA (US); Emilio Castro PASSI, San Francisco, CA (US); Nathan Daniel COX, Palo Alto, CA (US); Jared Terry BENSON, Pleasant Hill, CA (US); Shayne Sierra INGHAM, San Francisco, CA (US)

(21) Appl. No.: 15/445,886

(22) Filed: Feb. 28, 2017

Related U.S. Application Data
(63) Continuation of application No. 15/432,800, filed on Feb. 14, 2017.

(51) Int. Cl. G06F 3/0488; G06F 21/44

(52) U.S. Cl. CPC G06F 3/0488; G06F 2203/04803; G06F 21/44

(57) ABSTRACT

Authentication of a computing device involves displaying a plurality of subareas on a touchscreen display of a computing device, detecting a touch contact in a first subarea of the plurality of subareas, detecting a first swipe gesture from the first subarea to a second subarea of the plurality of subareas, detecting a first confirmation gesture associated with the first swipe gesture, and authenticating the computing device based at least in part on the first swipe gesture.

### CROSS-REFERENCE TO RELATED APPLICATION(S)

This application is a continuation of U.S. patent application Ser. No. 15/432,800, filed on Feb. 14, 2017 and entitled GESTURAL SWIPE USER INPUT, the disclosure of which is hereby incorporated by reference in its entirety.

### BACKGROUND

### Field

The present disclosure generally relates to the field of computing devices having touch-screen displays.

### Description of Related Art

Computing devices, such as wearable computing devices, can incorporate touch-screen displays for receiving user input.

### BRIEF DESCRIPTION OF THE DRAWINGS

Various embodiments are depicted in the accompanying drawings for illustrative purposes, and should in no way be interpreted as limiting the scope of the inventions. In addition, various features of different disclosed embodiments can be combined to form additional embodiments, which are part of this disclosure. Throughout the drawings, reference numbers may be reused to indicate correspondence between reference elements.

FIG. 1 is a block diagram illustrating an embodiment of a computing device in accordance with one or more embodiments.

FIG. 2 shows perspective front and side views of a wearable computing device in accordance with one or more embodiments.

FIG. 3 illustrates a touchscreen for a computing device in accordance to one or more embodiments.

FIGS. 4A-4D illustrate wearable computing devices having touchscreen displays in accordance with one or more embodiments.

FIG. 5 illustrates an embodiment of a touchscreen display configured for entry of digits by a user using a number line swiping method in accordance with one or more embodiments.

FIG. 6 illustrates an embodiment of a touchscreen display configured for entry of digits by a user using a circular number line swiping method in accordance with one or more embodiments.

FIG. 7 illustrates an embodiment of a touchscreen display configured for entry of digits by a user using a number line swiping method in accordance with one or more embodiments.

FIG. 8 illustrates a flow diagram for a process for authenticating a computing device in accordance with one or more embodiments.

FIG. 9 illustrates a process for authenticating a computing device in accordance with one or more embodiments.

FIGS. 10A-10D illustrate embodiments of wearable computing devices having touchscreen displays functionally and/or visually partitioned into subareas for user input in accordance with one or more embodiments.

FIG. 11 is a flow diagram illustrating a process for authenticating a computing device in accordance with one or more embodiments.

FIGS. 12 and 13 provide images of the respective computing devices corresponding to the various steps or stages of the process of FIG. 11 in accordance with one or more embodiments.

### DETAILED DESCRIPTION

Although certain preferred embodiments and examples are disclosed below, inventive subject matter extends beyond the specifically disclosed embodiments to other alternative embodiments and/or uses and to modifications and equivalents thereof. Thus, the scope of the claims that may arise herefrom is not limited by any of the particular embodiments described below. For example, in any method or process disclosed herein, the acts or operations of the method or process may be performed in any suitable sequence and are not necessarily limited to any particular disclosed sequence. Various operations may be described as multiple discrete operations in turn, in a manner that may be helpful in understanding certain embodiments; however, the order of description should not be construed to imply that these operations are order dependent. Additionally, the structures, systems, and/or devices described herein may be embodied as integrated components or as separate components. For purposes of comparing various embodiments, certain aspects and advantages of these embodiments are described. Not necessarily all such aspects or advantages are achieved by any particular embodiment. Thus, for example, various embodiments may be carried out in a manner that achieves or optimizes one advantage or group of advantages as taught herein without necessarily achieving other aspects or advantages as may also be taught or suggested herein.

The headings provided herein are for convenience only and do not necessarily affect the scope or meaning of the claimed invention. Like reference numbers and designations in the various drawings may or may not indicate like elements.

Overview

In view of security and/or other concerns, computing devices may advantageously implement authentication processes and mechanisms whereby a user may provide authentication input to verify that he or she is authorized to view or access certain applications and/or data of the computing device. For example, where a computing device is configured to implement financial transactions, such as to pay for goods, services, or the like through interfacing with a financial transactional system, it may be desirable for user authentication requirements to be implemented in order to ensure that the appropriate individual or entity is executing the relevant financial transaction. Furthermore, user authentication may be desirable prior to allowing any access to a user to operate a computing device. For example, a computing device may implement a locked state, wherein access to data and/or applications of device restricted in the locked state prior to entry of an authentication code by the user, which may serve to unlock the computing device.

User input for computing devices may be achieved in various ways, such as through the use of hard key, or soft key touchscreen buttons, for example. While certain touchscreen computing devices may provide a full visual keyboard display on the touchscreen providing standard alphanumeric keys, such as in a standard four-line QWERTY keyboard configuration for text entry, or a standard four-line, ten-digit number pad, some embodiments of computing devices having relatively small screens, such as wearable computing devices, may advantageously provide user input mechanisms for imputing authentication codes without the need of a full alphanumeric keyboard display on the touchscreen display. However, size constraints and/or other considerations may make user input mechanisms using other input means desirable. For example, certain computing devices may comprise touchscreens having a screen size that may benefit from alternative user input mechanisms, such as wearable computing devices, such as smart watches or the like, or certain other computing devices, including smart phones, tablet computers, or the like.

Certain embodiments disclosed herein provide systems and methods for implementing user authentication of computing devices using one or more gestural swipes on a touchscreen display, wherein the positioning of touch points associated with the gestures swipe may provide user input for authenticating the computer device. Some embodiments provide a touchscreen display configured to present a user input area for executing gestural swipes thereon. For example, the touchscreen display of the computing device may present instructions and/or indications of how to interact with the authentication process of the computing device.

In certain embodiments, when a finger or other member is pressed on the touchscreen display, an indication of a current value associated with the touch point may be presented on the display. When the user swipes or scrubs the finger or other member on the touchscreen display in one direction, the displayed value associated with the touch point may be increased according to the movement in that direction, while swiping or scrubbing the finger in another direction, such as in an opposite direction, may cause the value displayed to be decremented or decreased according to the movement in such direction. When the user removes his or her finger from the touchscreen display, the value associated with the touch point of the finger at the time of removal may be entered as a digit of an authentication code or pin. Once entered, the value of the authentication code digit may be obfuscated on the display for security purposes. That is, removal of the users finger from the touchscreen display may represent a confirmation gesture for confirming entry of a digit of an authentication code. Although certain embodiments are disclosed herein in the context of confirmation gestures involving the lifting of a finger off the display by a user, it should be understood that confirmation gestures for entry of authentication code digits in accordance with the present disclosure may be any suitable or desirable gesture, including but not limited to, double-tap, tap, long-old, flick, drag, or other types of gestures. The action of touching the touchscreen display and swiping or scrubbing in a desired direction and executing a confirmation gesture to input authentication code digits may be repeated as necessary in order to enter the required number of authentication code digits to authenticate the computing device.

Embodiments disclosed herein provide for inputting authentication code digits using gestural swipe input, as described, may provide various advantages over certain other user authentication code input systems and/or methods. For example, embodiments disclosed herein may provide for relatively easy-to-use user input entry for touchscreen displays having limited touch target sizing. Furthermore, gestural swipe entry methods disclosed herein may provide a relatively unique or engaging user input experience. In certain embodiments, haptic feedback may be provided by the computing device in connection with execution of gestural swipe digit entry to provide additional user notification/feedback regarding successful and/or unsuccessful input by the user.

In certain embodiments, the authentication code input area of the testing display may provide a hidden number line or slider feature, wherein separate values may be distributed across an axis or area of the hidden number line/slider. In certain embodiments, the number line may be associated with values that incrementally increase in one direction, thereby allowing the user to anticipate the location of higher or lower values intuitively. Therefore, the user may be enabled to relatively quickly execute a swipe or scrub gesture to the desired location of the number line.

In some implementations, the present disclosure relates to a method of entering an authentication code using a computing device. The method may comprise inputting an authentication code to authenticate a computing device at least in part by touching a first touch point on a display of a computing device to cause a first character associated with the first touch point to be displayed on the display, executing a first swipe gesture from the first touch point to a second touch point to cause a second character associated with the second touch point to be displayed on the display, executing a confirmation gesture to cause the second character to be input as a first digit of an authentication code, touching a third touch point on the display to cause a third character associated with the third touch point to be displayed on the display, executing a second swipe gesture from the third touch point to a fourth touch point to cause a fourth character associated with the fourth touch point to be displayed on the display, and executing the confirmation gesture to cause the fourth character to be input as a second digit of the authentication code. In certain embodiments, the display comprises an authentication code display portion and a code input portion, wherein the first, second, third, and fourth touch points are in the code input portion. Causing the first character to be displayed on the display may involve causing the first character to be displayed in the authentication code display portion.

In certain embodiments, said touching the first touch point on the display causes a number line to appear on the display, wherein the first touch point corresponds to a first point on the number line. The number line may be divided into a plurality of segments, wherein each segment is associated with a separate character of a set of characters. For example, the set of characters may comprise numeric digits 0-9. Alternatively, the set of characters may comprise a subset of the set of numeric digits 0-9. In certain embodiments, the number line is a straight number line. The computing device may be a wrist-wearable computing device comprising a band having a longitudinal axis, wherein the number line is a horizontal line substantially perpendicular to the axis of the band. Alternatively, the computing device may be a wrist-wearable computing device comprising a band having a longitudinal axis, wherein the number line is a vertical line substantially parallel to the axis of the band. In certain embodiments, when the first character is caused to be displayed on the display, the first character appears on the display above the number line as to not be covered by a finger of the user touching the first touch point. The number line may be a circular number line, wherein the first swiping gesture comprises a swipe along the circular number line.

In certain embodiments, when the first swipe gesture is in a first direction, the second character has a higher value than the first character, and when the first swipe gesture is in a second direction, the second character has a value less than the first character. Executing the confirmation gesture may comprise lifting the user's finger off of the display. In certain embodiments, authenticating the computing device authorizes a payment transaction. The method may further comprise executing a gesture indicating that the second character is a final character of the authorization code.

In some implementations, the present disclosure relates to a method of authenticating a computing device. The method may comprise displaying an authentication code display area and an authentication code input area on a touchscreen display of a computing device, detecting a touch contact at a first touch point in the authentication code input area, presenting a first character associated with the first touch point on the display, detecting a first swipe gesture from the first touch point to a second touch point, presenting a second character associated with the second touch point, detecting a confirmation gesture associated with the second touch point, detecting a touch contact at a third touch point in the authentication code input area, presenting a third character associated with the third touch point, detecting a second swipe gesture from the third touch point to a fourth touch point, presenting a fourth character associated with the fourth touch point, detecting a confirmation gesture associated with the fourth touch point, and authenticating the computing device based at least in part on the second and fourth characters.

In certain embodiments, the method further comprises presenting a number line on the display, wherein the second touch point corresponds to a point on the number line. A size of the number line may be based at least in part on a speed of the first swipe gesture.

In certain embodiments, the first character is a default character and a value of the second character relative to the first character is based at least in part on a direction of the first swipe gesture along the number line. The number line may be divided into a plurality of segments, wherein each segment is associated with a separate character of a set of characters. The computing device may be a wrist-wearable computing device comprising a band having a longitudinal axis, wherein the number line is a horizontal line substantially perpendicular to the axis of the band. Alternatively, the band may have a longitudinal axis, wherein the number line is a vertical line substantially parallel to the axis of the band. Presenting the second character may comprise presenting the second character above the number line.

Detecting the confirmation gesture associated with the second touch point may comprise detecting lift-off of a user's finger from off the second touch point. In certain embodiments, the method is performed in response to receiving a request to access protected application of the computing device. The computing device is a wearable computing device, wherein the method is performed in response to detecting that the wearable computing device has been put on by a user.

In some implementations, the present disclosure relates to a wearable computing device comprising an electronic touchscreen display and control circuitry. The control circuitry may be configured to display an authentication code display area and an authentication code input area on the display, detect a touch contact at a first touch point in the authentication code input area, present a first character associated with the first touch point on the display, detect a first swipe gesture from the first touch point to a second touch point, present a second character associated with the second touch point, detect a confirmation gesture associated with the second touch point, detect a touch contact at a third touch point in the authentication code input area, present a third character associated with the third touch point, detect a second swipe gesture from the third touch point to a fourth touch point, present a fourth character associated with the fourth touch point, detect a confirmation gesture associated with the fourth touch point, and authenticate the computing device based at least in part on the second and fourth characters. The control circuitry may be further configured to present a number line on the display, wherein the second touch point corresponds to a point on the number line. In certain embodiments, a size of the number line is based at least in part on a speed of the first swipe gesture.

### Touchscreen Computing Devices

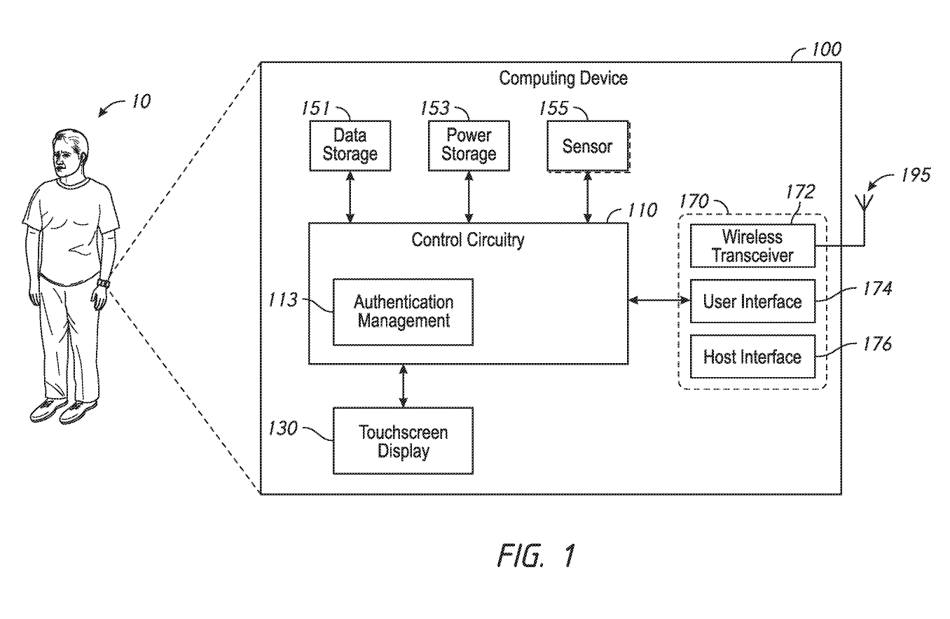

FIG. 1 is a block diagram illustrating an embodiment of a computing device 100 in accordance with one or more embodiments disclosed herein. In certain embodiments, the computing device 100 may be worn by a user 10, such as with respect to embodiments in which the computing device 100 is a wearable biometric monitoring device. For example, the computing device 100 may comprise a wearable biometric monitoring device configured to gather data regarding activities performed by the wearer, or regarding the wearer's physiological state. Such data may include data representative of the ambient environment around the wearer or the wearer's interaction with the environment. For example, the data may comprise motion data regarding the wearer's movements, ambient light, ambient noise, air quality, etc., and/or physiological data obtained by measuring various physiological characteristics of the wearer, such as heart rate, perspiration levels, and the like. Although certain embodiments are disclosed herein in the context of biometric monitoring devices, it should be understood that touchscreen user input principles and features disclosed herein may be applicable with respect to any suitable or desirable type of computing device, whether wearable or not.

The computing device 100 may include one or more electronic touchscreen display units or modules 130. In certain embodiments, the electronic display 130 may be associated with the front side of the computing device 100. For example, in wearable embodiments of the computing device 100, the electronic display 130 may be configured to be externally presented to a user viewing the computing device 100. In certain embodiments, the display 130 is an organic light emitting diode (OLED) display.

The computing device 100 includes control circuitry 110. Although certain modules and/or components are illustrated as part of the control circuitry 110 in the diagram of FIG. 1, it should be understood that control circuitry associated with the computing device 100 and/or other components or devices in accordance with the present disclosure may include additional components and/or circuitry, such as one or more of the additional illustrated components of FIG. 1. Furthermore, in certain embodiments, one or more of the illustrated components of the control circuitry 110 may be omitted and/or different than that shown in FIG. 1 and described in association therewith. The term “control circuitry” is used herein according to its broad and/ordinary meaning, and may include any combination of software and/or hardware elements, devices or features, which may be implemented in connection with operation of the computing device 100. Furthermore, the term “control circuitry” may be used substantially interchangeably in certain contexts herein with one or more of the terms “controller,” “integrated circuit,” “IC,” “application-specific integrated circuit,” “ASIC,” “controller chip,” or the like.

The control circuitry 110 may comprise one or more processors, data storage devices, and/or electrical connections. For example, the control circuitry 110 may comprise one or more processors configured to execute operational code for the computing device 100, such as firmware or the like, wherein such code may be stored in one or more data storage devices of the computing device 100. In one embodiment, the control circuitry 110 is implemented on an SoC (system on a chip), though those skilled in the art will recognize that other hardware/firmware implementations are possible.

The control circuitry 110 may comprise an authentication management module 113. The backlighting management module 111 may comprise one or more hardware and/or software components or features configured to control user authentication functionality in connection with the touchscreen display 130. In certain embodiments, the authentication management module 113 may be configured to detect and interpret swipe gestures on the touchscreen display by the user, and to authenticate the computing device 100, or one or more features thereof, for the user.

The computing device may further comprise one or more data storage modules 151, which may include any suitable or desirable type of data storage, such as solid-state memory, which may be volatile or non-volatile. Solid-state memory of the computing device 100 may comprise any of a wide variety of technologies, such as flash integrated circuits, Phase Change Memory (PC-RAM or PRAM), Programmable Metallization Cell RAM (PMC-RAM or PMCm), Ovonic Unified Memory (OUM), Resistance RAM (RRAM), NAND memory, NOR memory, EEPROM, Ferroelectric Memory (FeRAM), MRAM, or other discrete NVM (non-volatile solid-state memory) chips. The data storage 151 may be used to store system data, such as operating system data and/or system configurations or parameters. The computing device 100 may further comprise data storage utilized as a buffer and/or cash memory for operational use by the control circuitry 110.

The computing device 100 further comprises power storage 153, which may comprise a rechargeable battery, one or more capacitors, or other charge-holding device(s). The power stored by the power storage module 153 maybe utilized by the control circuitry 110 for operation of the computing device 100, such as for powering the touchscreen display 130. The power storage module 153 may receive power over the host interface 176 or through other means.

The computing device 100 may further comprise one or more connectivity components 170, which may include, for example, a wireless transceiver 172. The wireless transceiver 172 may be communicatively coupled to one or more antenna devices 195, which may be configured to wirelessly transmit/receive data and/or power signals to/from the computing device. For example, the wireless transceiver 172 maybe utilized to communicate data and/or power between the computing device 100 and an external host system (not shown), which may be configured to interface with the computing device 100. In certain embodiments, the computing device 100 may comprise additional host interface circuitry and/or components 176, such as wired interface components for communicatively coupling with a host device or system to receive data and/or power therefrom and/or transmit data thereto.

The connectivity circuitry 170 may further comprise user interface components 174 for receiving user input. For example, the user interface 174 may be associated with the touchscreen display 130, wherein the touchscreen display is configured to receive user input from user contact therewith. The user interface module 174 may further comprise one or more buttons or other input components or features.

The connectivity circuitry 170 may further comprise the host interface 176, which may be, for example, an interface for communicating with a host device or system (not shown) over a wired or wireless connection. The host interface 176 may be associated with any suitable or desirable communication protocol and/or physical connector, such as Universal Serial Bus (USB), Micro-USB, WiFi, Bluetooth, FireWire, PCIe, or the like. For wireless connections, the host interface 176 may be incorporated with the wireless transceiver 172.

Although certain functional modules and components are illustrated and described herein, it should be understood that authentication management functionality in accordance with the present disclosure may be implemented using a number of different approaches. For example, in some implementations the control circuitry 110 may comprise one or more processors controlled by computer-executable instructions stored in memory so as to provide functionality such as is described herein. In other implementations, such functionality may be provided in the form of one or more specially-designed electrical circuits. In some implementations, such functionality may be provided by one or more processors controlled by computer-executable instructions stored in a memory coupled with one or more specially-designed electrical circuits. Various examples of hardware that may be used to implement the concepts outlined herein include, but are not limited to, application specific integrated circuits (ASICs), field-programmable gate arrays (FPGAs), and general-purpose microprocessors coupled with memory that stores executable instructions for controlling the general-purpose microprocessors.

Wearable Computing Devices with Touchscreen Displays

In some implementations, a touchscreen-enabled computing device may be designed to be insertable into a wearable case or into one or more of multiple different wearable cases (e.g., a wristband case, a belt-clip case, a pendant case, a case configured to be attached to a piece of exercise equipment such as a bicycle, etc.). In other implementations, a touchscreen computing device may be designed to be worn in limited manners, such as a computing device that is integrated into a wristband in a non-removable manner, and may be intended to be worn specifically on a person's wrist (or perhaps ankle). Irrespective of configuration, wearable computing devices having touchscreen functionality may be configured to implement gestural-swipe-based authentication in accordance with various embodiments disclosed herein.

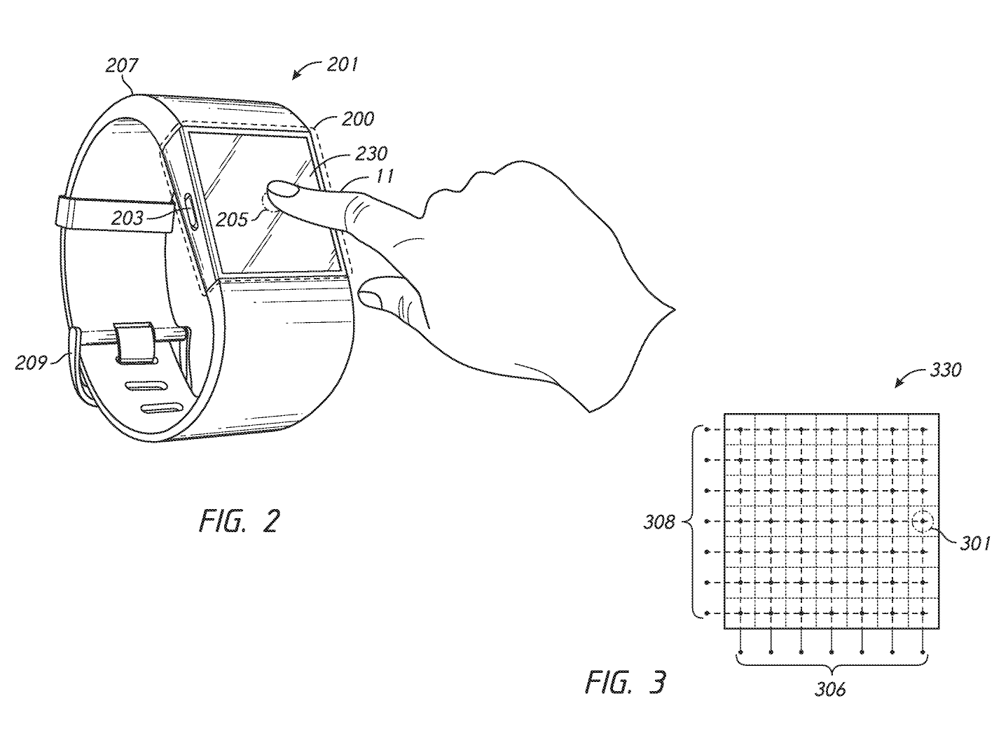

Wearable computing devices according to embodiments and implementations described herein may have shapes and sizes adapted for coupling to (e.g., secured to, worn, borne by, etc.) the body or clothing of a user. An example of a wearable computing device 201 is shown in FIG. 2. FIG. 2 shows perspective front and side views of the wearable computing device 201. The wearable computing device 201 includes both a computing device 200, as well as a band portion 207. In certain embodiments, the band portion 207 includes first and second portions that may be connected by a clasp portion 209. The computing device portion 200 may be insertable, and may have any suitable or desirable dimensions. Wearable computing devices may generally be relatively small in size so as to be unobtrusive for the wearer, and therefore, the touchscreen display 230 may be relatively small in size relative to certain other computing devices. The computing device 200 may be designed to be able to be worn without discomfort for long periods of time and to not interfere with normal daily activity.

The electronic display 230 may comprise any type of electronic display known in the art. For example, the display 230 may be a liquid crystal display (LCD) or organic light emitting diode (OLED) display, such as a transmissive LCD or OLED display. The electronic display 230 may be configured to provide brightness, contrast, and/or color saturation features according to display settings maintained by control circuitry and/or other internal components/circuitry of the computing device 200.

The touchscreen 230 may be a capacitive touchscreen, such as a surface capacitive touchscreen or a projective capacitive touch screen, which may be configured to respond to contact with electrical charge-holding members or tools, such as a human finger. FIG. 3 illustrates a touchscreen 330 for a computing device according to one or more embodiments. The touchscreen 230 may comprise one or more wires (306, 308) configured to store electrical charges in a grid configuration. For example, the wires (306, 308) may comprise one or more of copper, indium tin oxide, or the like. The wires may provide a grid of rows 308 and columns 306 coupled to sensing circuitry (not shown). In certain embodiments, in operation, when a finger contacts the screen at a touchpoint 301, electrical charge may be transferred to the finger to complete a circuit, creating a voltage drop at the touchpoint 301. Processing circuitry (not shown) associated with the touchscreen 330 may process the location of the voltage drop for operational purposes. The intersections of the rows and columns may form cells, as shown, wherein each cell corresponds to a unique touchpoint for the touchscreen 330.

### Touchscreen User Input

User input functionality using touchscreen displays may be implemented in a variety of ways, such as through a full number pad, a number tumbler, free-hand marking, or the like. Certain embodiments, disclosed herein provide for touchscreen user input through the use of gestural swipes (horizontal or vertical), which may be used to select a number or other character for inputting among a number/character set. In certain embodiments, when no finger is placed on the screen, an indication may be shown regarding how to interact with the user input system. In certain embodiments, while a finger is pressed against the screen, an indication of a current value associated with the current touchpoint may be shown. Swiping or scrubbing the finger in one direction may increase the value, while scrubbing in the opposite may decrease the value. In certain embodiments, once the user's finger is removed from the screen, the value may be obfuscated and added as a digit of an authentication code. The gestural swiping/scrubbing action may be repeatable for as many authentication code digits are necessary.

In certain embodiments, the gestural swiping feature may provide an at least partially hidden slider or number line, wherein values are distributed across the axis of the slider/number line. Therefore, the user may be able to anticipate where higher digits (e.g., the number 9 in a 0-9 number set) can be found. The user may be able to relatively quickly and easily “scrub” in a code compared to, for example, certain number tumbler embodiments.

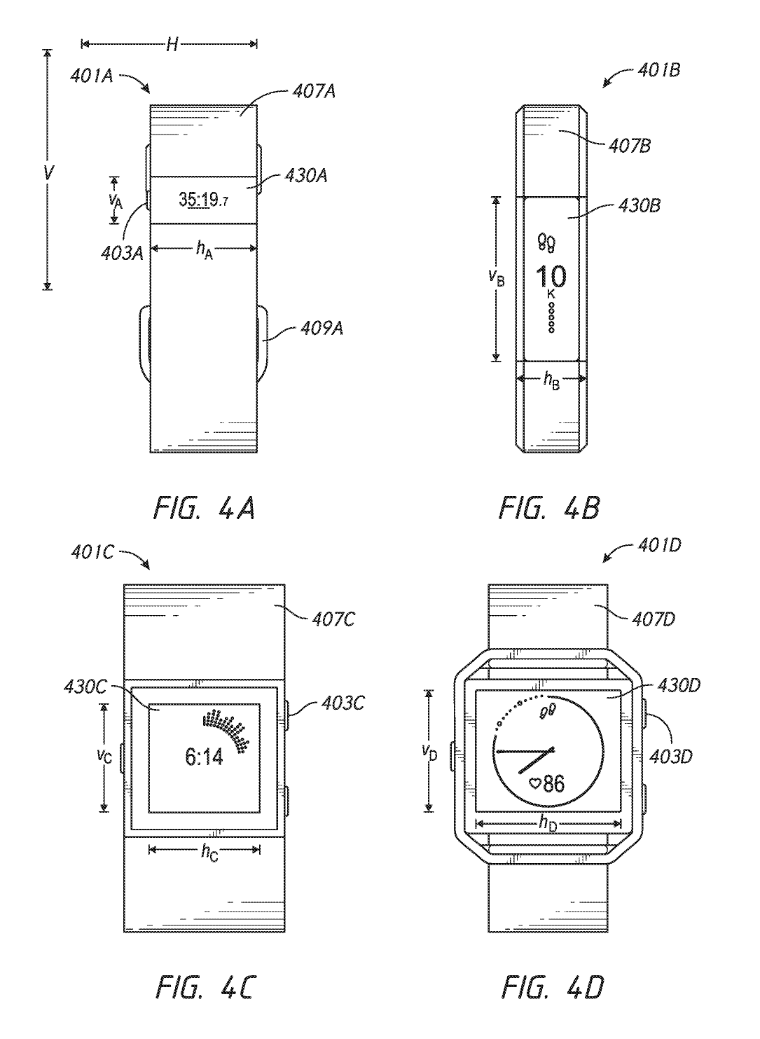

FIGS. 4A-4D illustrate wearable computing devices having touchscreen displays in accordance with one or more embodiments. The computing devices of FIGS. 4A-4D are illustrated in a generally vertical orientation, represented by the vertical axis V, wherein a horizontal axis is represented as the axis H.

FIG. 4A illustrates a wearable computing device 401A having a generally rectangular display 430A. The wearable computing device 401A may further comprise a band component 417A, which may be used to secure the computing device 401A to an arm, wrist, or other member of the user. The band 407A may be secured about the user's member using a clasp 409A or other type of attachment mechanism. In certain embodiments, in addition to the touchscreen display 430A, the computing device 401A may comprise one or more physical user input buttons 403A for receiving user input.

The computing device 401A includes a generally rectangular-shaped touchscreen display 430A, which may have a horizontal dimension h_{A} that is greater than an associated vertical dimension v_{A} of display 430A, as shown. The computing device 401A may be configured to display text and/or other visual elements on the display 430A in a generally horizontal manner along the horizontal dimension h, which may advantageously be viewable by a user wearing the device about, for example, the user's wrist, wherein the user's arm, when the wearable computing device 401A is secured about the user's wrist, is generally parallel with the horizontal axis h and horizontal dimension h_{A} of the computing device 401A. The display 430A of the computing device 401A may represent a relatively small touchscreen display, wherein implementation of a full numeric keypad on the display 430A for authentication code input may be undesirable and/or impractical.

FIG. 4B illustrates a wearable computing device 401B having a generally rectangular display 430B. The wearable computing device 401B may further comprise a band component 407B, which may be used to secure the computing device 401B to an arm, wrist, or other member of the user. The band 407B may be secured about the user's member using any suitable or desirable type of attachment mechanism (not shown). In certain embodiments, in addition to the touchscreen display 430B, the computing device 401B may comprise one or more physical user input buttons (not shown) for receiving user input.

The computing device 401B includes a generally rectangular-shaped touchscreen display 430A, which may have a vertical dimension v_{B} that is greater than an associated horizontal dimension h_{B} of display 430B, as shown. The computing device 41 a may be configured to display text and/or other visual elements on the display 430B in a generally horizontal manner along the horizontal dimension h, which may advantageously be viewable by a user wearing the device about, for example, the user's wrist, wherein the user's arm, when the wearable computing device 401B is secured about the user's wrist, is generally parallel with the horizontal axis h and horizontal dimension h_{B} of the computing device 401B. Additionally or alternatively, the display 430B may display text and/or other visual elements in a generally vertical manner. The display 430B of the computing device 401B may represent a relatively small touchscreen display, wherein implementation of a full numeric keypad on the display 430B for authentication code input may be undesirable and/or impractical.

FIG. 4C illustrates a front view of a wearable computing device 401C, comprising a touchscreen display 430C, as well as a band portion 407C for securement to a user, as described above in connection with FIGS. 4A and 4B. The display 430C of the computing device 401C may represent a display having a generally rectangular shape, wherein the display may have a square shape, or alternatively the vertical dimension v_{C} of the display may be slightly greater than the horizontal dimension h_{C}. Although the display 430C may be larger with respect to one or more dimensions thereof compared to one or more of the respective displays of FIG. 4A or 4B, it may be desirable for the computing device 401C to be configured for accepting abbreviated user input relative to full number pad display entry.

FIG. 4D illustrates a front view of a wearable computing device 401D, comprising a touchscreen display 430D and a band portion 407D for securement to a user, as described above in connection with FIGS. 4A and 4B. The display 430D of the computing device for one seat may represent a display having a generally rectangular shape, wherein the display may have a square shape, or alternatively the horizontal dimension h_{C} of the display may be slightly greater than the horizontal dimension h_{C}. Although the display 430D may be larger with respect to one or more dimensions thereof compared to one or more of the respective displays of FIG. 4A or 4B, it may be desirable for the computing device 401D to be configured for accepting abbreviated user input relative to full keypad display entry.

### Computing Device Authentication

As described above, device authentication may be desirable to protect access to data and/or processes of computing device in certain situations. Authentication of computing device may involve entry of an authentication code, such as a password or the like. In certain embodiments, a display of the computing device may present a user authentication interface that allows for input by the user of an authentication code to gain access to the computing device and/or one or more components or functionalities thereof. For example, an authentication interface, which may be presented when the computing device is in a locked, or secured, state may serve to protect the device from unauthorized use, while maintaining access to certain functionality of the computing device, such as a time display or watch face feature, or other feature that is not protected by the authentication management system. User authentication may be implemented in connection with any desirable process, data, or functionality of the computing device. For example, user authentication may be required in order to access financial transaction processes, such as a wallet-type application or the like. In certain embodiments, a user authentication management system of a computing device protects against access to all non-clock screens when the devices in a locked state.

Input of an authentication code by user may be implemented according to any suitable or desirable mechanism in accordance with the present disclosure. For example, in certain embodiments, authentication input may be implemented through recognition of one or more biometric parameters associated with the user. For example, where the computing device is a wearable biometric monitoring device, the device may be configured to monitor and/or interpret certain biometric parameters, such as walking or running gait pattern, pulse and/or heart rate, fingerprint, retinal scan, or other biometric input mechanism.

In some implementations, a computing device is configured to receive authentication code input from a user through a numeric keypad interface displayed on, for example, a touchscreen display of the computing device. Alternatively, authentication code digit entry may be implemented using one or more of a traditional full number pad, a numeric tumbler, handwritten entry, pattern recognition (e.g., connection of dots with a finger pattern), or other visual and/or gestural mechanism. With regard to numeric code entry, such as numeric pin entry, user input may be achieved through the display and associated interaction therewith of a standard 10-digit number pad, or abbreviated number pad comprising a subset of the standard 10-digit number pad. Certain embodiments disclosed herein provide for authentication code input through the use of swipe gestures.

Certain embodiments disclosed herein provide for user authentication code entry using a touchscreen of a computing device, wherein a number line or other mechanism is used for simplified digit entry as an alternative to, or in addition to, a full number pad. For example, while certain touchscreen displays for computing devices may have a shape and/or size conducive to display and/or utilization of a full number pad, certain computing devices, such as certain wearable computing devices, may incorporate touchscreen displays having a shape and/or size that may necessarily or desirably utilize a simplified digit entry mechanism. For example, the touchscreen displays 430A and 403B shown in FIGS. 4A and 4B, respectively, may represent displays having a shape and/or size for which it may be desirable to utilize a number line or other simplified user input entry mechanism, as described herein.

Certain embodiments of touchscreen displays disclosed herein are configured to allow for swipe-gesture digit entry, wherein when a user touches and/or swipes on the display, a number or other character associated with the current touch point is displayed on the display and modified in accordance with movement of the user's finger along the swipe path. In certain embodiments, digits of an authentication code may be entered by a user using such swiping gestures in a digit-by-digit manner in order to input multiple digits of an authentication code to thereby authenticate the computing device.

### Number Line for User Input

For touchscreen displays implementing gestural swipe input according to the present disclosure, the touchscreen display may be configured to provide a user input area, wherein separate portions or areas of the user input area are associated with different values of a character or number set. For example, the separate portions or areas of the display that correspond to separate input values may each be associated with a number line (or character line), wherein the values of the characters associated with the number line are spread out incrementally along the number line. The use of a number line, as opposed to a full number pad, for entry of characters and/or digits of authentication codes, may provide for relatively easy input of data on relatively small touchscreen displays. By dispersing different character values incrementally along a number line, or the like, user input mechanisms in accordance with the present disclosure may allow for the user to hone in on a desired character value, as a contrast to traditional find-and-peck methods that may be associated with full number pad digit entry.

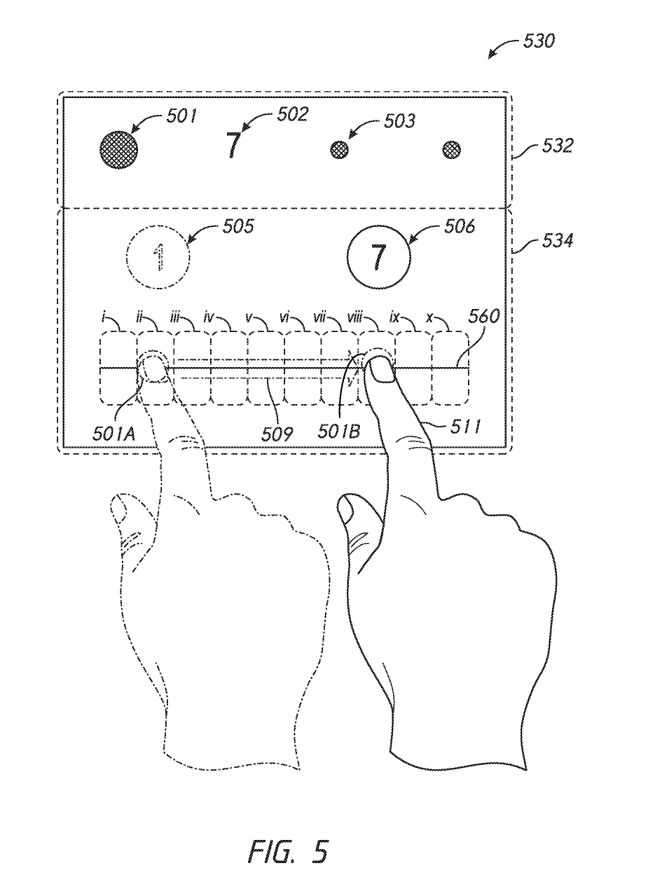

In certain embodiments, a gestural swipe on a touchscreen display, whether in a vertical, horizontal, or other direction, may be used as a number/character selection mechanism. FIG. 5 illustrates an embodiment of a touchscreen display 530 configured for entry of digits by a user using a number line swiping method according to the present disclosure. In certain embodiments, the touchscreen display 530 may be used to enter an authentication code, or other data comprising one or more digits. The touchscreen display 530 of FIG. 5 may include one or more regions, such as an authentication code display region 532 and an authentication code entry region 534. For example, while the authentication code entry region 534 may be used by the user for executing touch gestures for entry of an authentication code, one or more digits of the authentication code may be displayed in the authentication code display region 532.

In certain embodiments, the touchscreen display 530 may present the authentication code entry region 534 and the authentication code display region 532 only during certain operational periods or states, such as when the device associated with the display 530 is in a locked state and/or passcode-entry state. In certain embodiments, the authentication code display region 532 may present one or more icons, such as dots 501, 503 that are representative of one or more characters or digits of an authentication code. Although a four-digit authentication code is represented in the authentication code display region 532, it should be understood that embodiments disclosed herein relating to authentication code entry may be applicable to authentication codes having any suitable or desirable number of digits. In certain embodiments, the authentication code display region 532 may display a character value 502, such as a numbered value, associated with a current digit of the authentication code selected by the user, whereas once the user has moved on to a subsequent digit of the authentication code, the displayed character representation may change to an obfuscated icon, such as a circle or the like in order to at least partially obfuscate the entered character value for security/privacy purposes. For example, in one implementation, a larger circle 501 may be presented as representative of an entered digit, whereas a smaller circle or shape 503 may be presented as representative of a digit of the authentication code that is yet to be input by the user.

The authentication code entry region 534 may be configured such that the user may execute a gestural swipe gesture (in any direction) to select a number or character for entry as a digit of the authentication code. In certain embodiments, when no finger or other member or tool is placed on the screen, an indication may be displayed on the display (in either or both of the authentication code display region 532 and the authentication code entry region 534) providing instructions or guidance for how the user may interact with the authentication management functionality and/or touchscreen display 530 of the computing device in order to enter digits of the authentication code.

The authentication code entry region 534 of the display 530 may include a number line 560 or other representation of a range of character/number values for authentication code entry. Although the number line 560 is illustrated in the diagram of FIG. 5, it should be understood that in certain implementations, the number line 560 may not be visible; that is, the functionality of the number line 560 may be implemented as an invisible number line to the user. In certain embodiments, the number line 560 may appear in the authentication code entry region 534 in connection with the user making contact with the display screen 530, such as by making contact with a region of the authentication code entry region 534 associated with the number line 560.

The length of the number line 560 may be subdivided into separate regions thereof, wherein each of the separate regions may correspond to separate character value, such as a separate number of a finite number set. In one implementation, the number line 560 may be subdivided, as illustrated, into 10 subareas (i-x), each associated with one of the numbers 0-9. When the user contacts a touch point 501A on or associated with the number line 560, a character value 505 associated with the sub-region ii in which the touch point 501A is primarily positioned may be displayed to inform the user of the relative position of the touch point 501A on the number line 560. The user may implement a swipe gesture 509 by scrubbing or moving the user's finger 511 along the number line 560 from the first touch point area ii to a second touch point 501B positioned primarily in a second sub-region viii, at which point the user may identify the character value associated with the end touch point 501B as being a desired authentication code input or number. In association with the swiping gesture 509, the functionality of the number line 560 may be such that the displayed character value may change as the user's finger 511 moves from one sub-region of the number line 560 to another sub-region, wherein at each point sub-region along the number line 560, the character value associated with that sub-region of the number line 560 may be displayed. For example, as shown, the character associated with the currently-touched sub-region viii of the number line 560 may be displayed in an area of the display 530 that is lined-up or otherwise associated with the currently-touched sub-region viii of the number line. In some implementations, the character value of the currently-touched region of the number line 560 may be displayed in an area above the number line 560, or sub-region thereof. The position and/or location of the displayed characters 505, 506 may advantageously be designed to reduce or avoid obstruction of the viewing of such characters by the user during normal use of the computing device associated with the display 530.

In certain embodiments, when implementing the swipe gesture associated with number line 560, the character values associated with the respective regions of the number line 560 may be arranged such that swiping by the user's finger 511 in a first direction, such as to the right as shown in FIG. 5, may cause the character value (e.g., number value) to increase incrementally, while swiping or scrubbing in the opposite direction (e.g., to the left in the diagram FIG. 5) may cause the character value to decrease decrementally. In certain embodiments, deletion of an entered digit or character may be achieved through a deletion gesture or action, such as by tapping a top region of the display 530 and/or associated computing device (not shown). Other deletion gestures that may be implemented in connection with the embodiments of the present disclosure may include, for example, tapping one or more areas of the display, swipe-back gesture, shaking the computing device, two-finger tapping, use of a hard button of the computing device, or other means.

Although FIG. 5 is described herein in connection with authentication code entry, it should be understood that the gestural swipe mechanism described may be utilized for entry of other types of data, such as text entry, phone number entry, or the like. Furthermore, although the authentication code display region 532 is illustrated as being substantially above the authentication code entry region 534, it should be understood that the various regions or areas of the display 530 may have any desirable or suitable arrangements or configuration. For example, in some implementations, the authorization code display region 532 may be displayed aside or below the authentication code entry region 534.

With respect to authentication code management and/or entry, as described in detail herein, the setting of an authentication code by a user in connection with one or more of the disclosed embodiments may be implemented in any suitable or desirable manner. For example, in certain embodiments, authentication code setting may be implemented in connection with a companion experience, such as a web-based software application on a mobile phone or other computing device. In other embodiments, the authentication code may be set using the computing device itself. For example, in setting the authentication code, the digits of the authentication code may be entered using a number line or other user input mechanism or method in accordance with the present disclosure.

Once the user has found the region of the number line 560 that is associated with the desired character to be entered by the user, the user may execute a confirmation gesture indicating that the selected digit is desired to be entered as a digit in the authentication code or other data entry. In some embodiments, the confirmation gesture may comprise the raising or lifting-off of the users finger 511 from the display 530. For example, where the user has scrubbed his or her finger along a number line from a first touch point to a second touch point associated with the desired character value to be submitted, the user may execute the confirmation gesture simply by lifting his or her finger 511 off of the area (e.g., viii), which in the illustrated embodiment is associated with the desired authentication code number ‘7.’ By executing the confirmation gesture, the digit 502 in the display region 532 may become obfuscated, and the subsequent digit of the authentication code may be displayed or otherwise highlighted in the authentication code display region 532. Any suitable or desirable confirmation gesture may be implemented in accordance with the present disclosure, such as double-tap, two-finger tap, finger press, or the like.

Use of a number line, whether visible or invisible, may advantageously provide for a relatively fine level of control in selecting a digit for entry. As shown, the subareas (i-x) associated with the number line 560 may generally extend in directions perpendicular to the number line 560 away from the number line, such that touch points not overlapping or directly on the number line 560 may nevertheless be interpreted as corresponding to closest sub-regions of the number line 560, and associated character values. In certain embodiments, the size and/or configuration of the subareas or regions i-x may be designed to accommodate the size of the human finger vis-à-vis the size of the display.

Although a single horizontal number line 560 is shown in FIG. 5, as well as in certain other diagrams of the present disclosure, it should be understood that number lines used for data entry as described herein may comprise any suitable or desirable number and/or configuration of lines. For example, in one implementation, multiple parallel number lines may be displayed or used to enter gestural swiping thereon, which may allow for a relatively higher number of unique character values for the character set. Furthermore, although a generally horizontal number line 56 is illustrated, should be understood that the number line 560 may be vertical, diagonal, or have any other suitable or desirable layout or curvature with respect to the display 530.

Although a 10-character set is described in connection with the embodiment of FIG. 5, it should be understood that character sets having any number of characters may be used in accordance with embodiments of the present disclosure. For example, where a display may not have a size conducive to a full 10-number set, subsets of the numbers 0-9 may be used, such as a five-number set or other size set. Where smaller subsets are implemented, it may be desirable to increase the number of digits of the authentication code in order to achieve the desired level of security for the authentication management system.

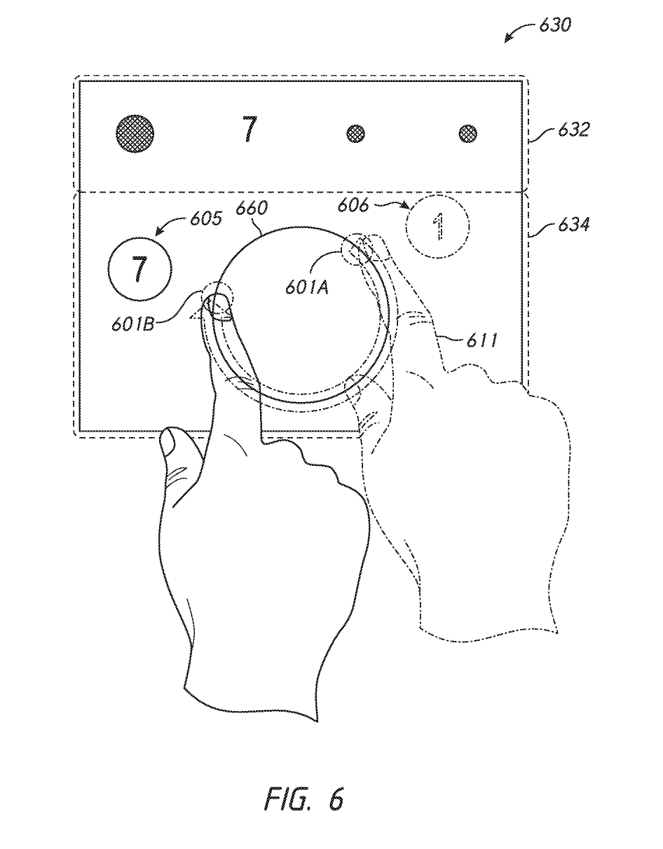

FIG. 6 illustrates an embodiment of a touchscreen display 630 configured for entry of digits by a user using a circular number line swiping method according to the present disclosure. In certain embodiments, the touchscreen display 630 may be used to enter an authentication code, or other data comprising one or more digits. The touchscreen display 630 of FIG. 6 may include one or more regions, such as an authentication code display region 632 and an authentication code entry region 634. The authentication code display region 632 and authentication code entry region 634 may have characteristics similar to those described above respect to FIG. 5.

The display 630 may be configured to implement an at least partially circular, or curved, number line 660. The circular number line 660 may be utilized for touch gestures by touching a first touch point (e.g., 601A) and swiping the finger 611 (or other member or tool used for contacting the display 630) along a curved path along the number line 662 to a desired endpoint (e.g., 601B) associated with a desired character (e.g., 605) to be entered as a digit of an authentication code or other text or character input. In certain embodiments, the character values associated with various points along the curved number line 660 may increment generally in a first circular direction (e.g., clockwise) and decrement in an opposite direction (e.g. counterclockwise). Although the number line 660 is shown as connecting to form a complete circle, in certain embodiments the number line may comprise a break therein, such that the number line has separate and distinct start and end points.

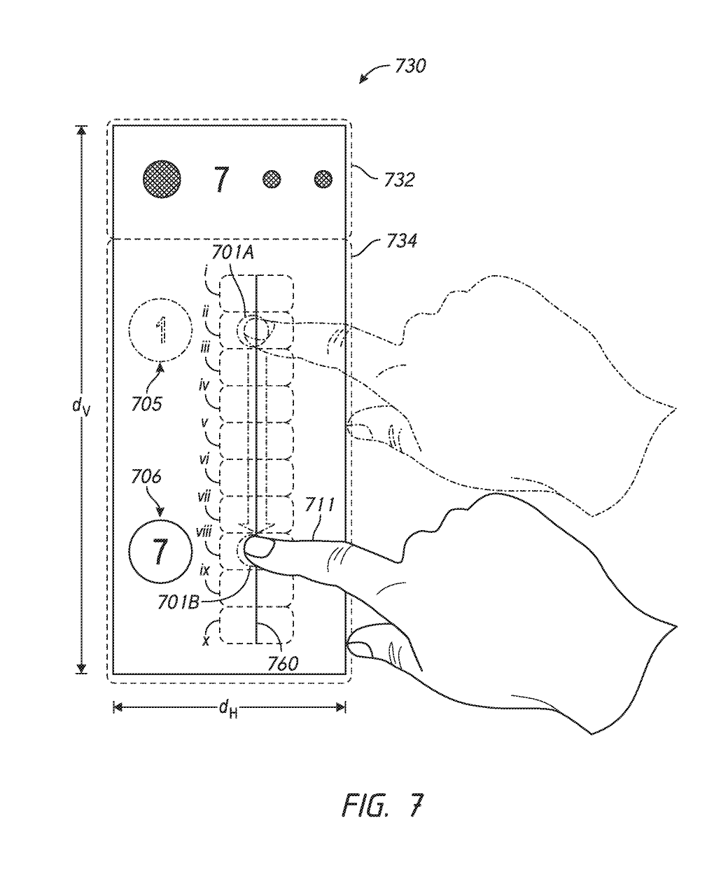

FIG. 7 illustrates an embodiment of a touchscreen display 730 that may have a generally vertical configuration. For example, the display 730 may have a vertical dimension dᵥ that is greater than the horizontal dimension dn. Although illustrated as a generally rectangular-shaped display, the display 730 may be at least partially curved in certain embodiments.

The display 730 is illustrated as comprising an authentication code display region 732 as well as an authentication code entry region 734. In certain embodiments, the number line 760 may have a generally vertical orientation, wherein the sub-regions of the display (i-x) associated with the number line 760 may be arranged in a vertically stacked configuration, as shown. In certain embodiments, the sub-regions i-x may extend horizontally, such that touch points that may not overlap or touch the number line 760 may nevertheless be associated with the number line 760 and/or characters assigned to the various regions of the number line 760.

In order to execute a swipe gesture for character entry, as described in detail herein, a user may touch a touchpoint (e.g., 701A) of the authentication code entry region 734 that is associated with the number line 760, such as at a first sub-region ii of the number line 760. When the first contact 701A is made with the sub-region ii, a character value 705 associated with such sub-region may be displayed on the display 730, such as to the side of the sub-region ii, as shown. The character associated with the current touch point may advantageously be presented in a position and/or manner as to reduce the occurrence of obstruction of such by the user's finger 711, or other obstruction. As the user moves his or her finger 711 in a direction generally parallel with the number line 760, the displayed character, and/or position of the displayed character, may change depending on the direction of movement. For example, with respect to the vertical number line 760 of FIG. 7, movement downward along the number line may increment the displayed value, while movement in the opposite direction may decrement the displayed value, or vice versa. When the user has found the sub-region of the number line 760 associated with the desired character to be submitted (e.g., viii), the user may execute a confirmation gesture to thereby enter the selected character as a digit of the authentication code or other text or data being entered by the user.

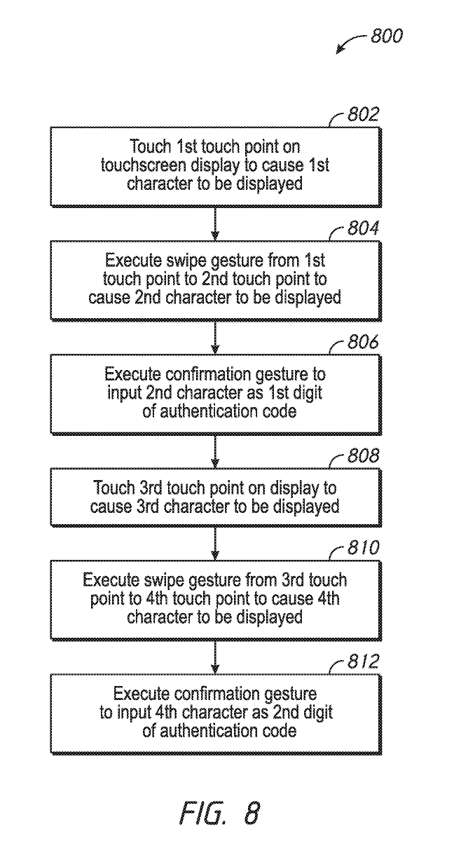

FIG. 8 illustrates a flow diagram for a process 800 for authenticating a computing device in accordance with the present disclosure. In certain embodiments, the process 800 may be performed at least in part by a user of a computing device having a touchscreen display and/or control circuitry of the computing device. For example, the user may be wearing a computing device on a wrist or other body part, or otherwise have the computing device attached to him or her, when performing at least part of the process 800. The process 800 may be performed in order to access authorized data and/or application(s) of the computing device, such as a payment application and/or associated data. Examples of applications and/or data that may be protected by the authentication management scheme associated with the process 800 may include a notification center application, music tray application, device settings utility, application and/or data shortcuts, financial transaction application(s), and/or other types of applications and/or data.

In certain embodiments, prior to execution of the first step 802 of the process 800, the computing device may be in an idle and/or locked state. For example, a display of the computing device may display at such time in idle-state screen, which may appear when the device is unauthenticated and the user attempts to navigate away from a default screen, such as a clock screen. When the user attempts to access a screen or otherwise interface with the display and/or computing device, an authentication code entry interface may be presented on the touchscreen display of the computing device. In certain embodiments, the process 800 may be implemented in connection with a wearable computing device that may be worn, for example, about a wrist or other member of the user. In certain embodiments, the authentication process 800 may be initiated when the user puts on the device and/or contacts a device with the user's skin. Alternatively, authentication processes in accordance with the present disclosure may be initiated after a predetermined period of time in an idle state, or in connection with a request to access protected applications and/or data.

At block 802, the process 800 involves touching a first touch point on the touchscreen display of the computing device, which may in turn cause a first character associated with the first touch point to be displayed on the display. For example, the first touch point may be associated with a number line or other feature, as described herein; the displayed character may correspond to a sub-region of the number line contacted by or overlapping the first touch point.

At block 804, the process 800 involves executing a swipe gesture from the first touch point to a second touch point, thereby causing a second character to be displayed, which may be associated with the second touch point. For example, the second touch point may be, similarly to the first touch point, associated with a sub-region of a number line or other visual or conceptual feature of the touchscreen display. In certain embodiments, execution of the swipe gesture may involve locating, by the user, the second touch point by examining displayed characters that may increment or decrement during movement along the swipe gesture path according to the direction of the swipe gesture. When the desired character is displayed during execution of the swipe gesture, the user may end the swipe gesture, thereby locating the second touch point as being the end point of the swipe gesture.

At block 806, the process 800 involves executing a confirmation gesture in order to input the second character as a digit of an authentication code. For example, the execution gesture may involve lifting-off of the second touch point once the second touch point has been located by the user. In one embodiment, the confirmation gesture may involve holding the second touch point for a period of time, after which the first digit may be entered. Once the confirmation gesture has been executed, the second character may be entered as a digit of the authentication code, such that a subsequent digit can then be entered by the user. In certain embodiments, the user may receive feedback from the computing device indicating successful entry of the first digit, such as haptic feedback, audio feedback, visual message feedback, or the like.

At block 808, the process 800 involves touching a third touch point on the display to cause a third character to be displayed. In certain embodiments, the third touch point may be the same as either the first touch point or the second touch point, such that the third character displayed may be the same as either the first or second characters displayed. For example, each of the displayed characters may be associated with a sub-region of a number line or other display feature, wherein each of the touch points of the process 800 may cause the corresponding character of the touch point to be displayed.

At block 810, the process 800 involves executing another swipe gesture from the third touch point to a fourth touch point, thereby causing a fourth character to be displayed. Once again, the fourth touch point may be the same as one or more of the first, second, and third touch points described above, wherein the fourth character may likewise be identical to one or more of the first, second, and third characters. The step at block 810 may involve locating the fourth character through visual feedback from the display, as described above with respect to location of the second character at block 804. For example, the user may examine displayed characters as the swipe gesture from the third touch point the fourth touch point is executed, wherein the fourth touch point is located by identifying when a desired character is displayed while executing the swipe gesture.

At block 812, the process 800 involves executing another confirmation gesture in order to cause the fourth character to be input as a second digit of the authentication code. Where the second digit is the last digit of an authentication code, the process 800 may terminate at that point with authentication of computing device. However, where additional digits of the authentication code remain to be input by the user, the process 800 may involve repeating one or more the process steps 802-812 in order to input one or more additional digits, as necessary, for authentication of computing device.

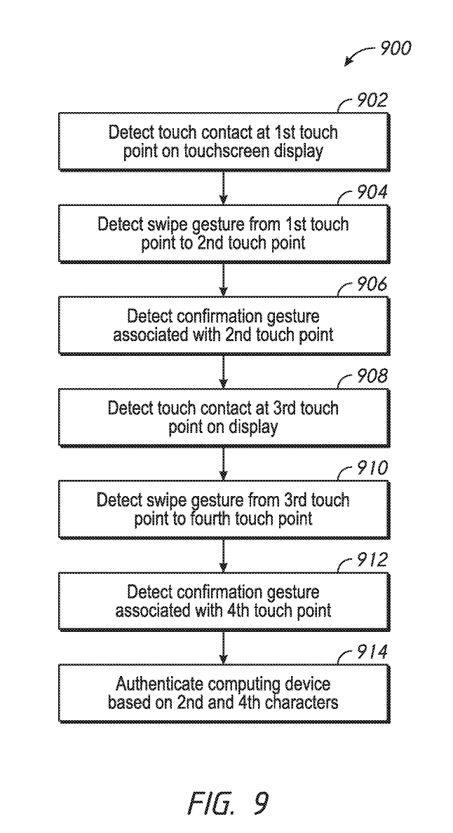

FIG. 9 illustrates a process 900 for authenticating a computing device in accordance with one or more embodiments disclosed herein. The process 900 may be performed at least in part by control circuitry of the computing device using one or more processors thereof, as well as an associated touchscreen display. At block 902, the process 900 involves detecting a touch contact at a first touch point on a touchscreen display of the computing device. In certain embodiments, the first touch point may be associated with a sub-region of a number line for other feature, which may be displayed on the touchscreen display.

At block 904, the process 900 involves detecting a swipe gesture from the first touch point to a second touch point on the touchscreen display. For example, the swipe gesture may be generally along a path of a number line, such as a straight and/or curved number line, or the like. The process 900 may further involve displaying a visual number line on the touchscreen display to provide an indication to the user of the general area and/or path to be followed for execution of swipe gestures.

At block 906 the process 900 involves detecting a confirmation gesture associated with the second touch point. For example, the confirmation gesture may be any type of confirmation gesture as described herein. When the confirmation gesture is detected at block 906, the process 900 may involve registering an input character associated with the second touch point as a digit of an authentication code for authenticating the computing device.

At block 908, the process 900 involves detecting another touch contact at a third touch point on the touchscreen display. For example, the third touch point may be the same as one or more of the first and second touch points, or maybe a separate touch point associated with a separate sub-region of a number line or the like.

At block 910, the process 900 involves detecting another swipe gesture from the third touch point to a fourth touch point, and further, at block 912, detecting a confirmation gesture associated with the fourth touch point. When the confirmation gesture associated with the fourth touch point is detected, the process 900 may involve registering a character associated with the fourth touch point and/or sub-region of the touchscreen display encompassing at least a portion of the fourth touch point as another digit of the authentication code. At block 914, the process 900 involves authenticating the computing device based on the second and fourth characters. For example, the second and fourth characters may represent digits of an authentication code, wherein the authentication code may have any desirable number of digits. Where the authentication code comprises more than the digits associated with the second and fourth characters, the process 900 may further involve repeating one or more steps of the process to detect one or more additional swipe gestures and/or confirmation gestures identifying one or more additional characters associated with the authentication code.

In certain embodiments, authenticating the computing device at block 914 may involve providing access to the user of the computing device to one or more applications and/or data protected by an authentication management scheme implemented using circuitry configured to perform at least part of the process 900.

In certain embodiments, the process 900 may involve determining that one or more characters received according to the process 900 does not match the authentication code, and therefore authentication of the computing device may fail at least in part. When failure occurs, the process 900 may involve providing feedback to the user, such as a form of haptic, audio, and/or visual feedback, indicating the failure.

### Touchscreen Display Subarea Partitioning for User Input

Certain embodiments disclosed herein provide systems and methods for user data input in computing devices using touchscreen displays having number line functionality implemented in connection there with. In addition to number lines and related visual and functional elements, the present disclosure relates to systems, devices, and methods providing for user data input on a touchscreen display through the visual and/or functional partitioning of at least a portion of the touchscreen display into a plurality of subareas, wherein the user may input data, such as authentication code data, by executing one or more swipe gestures originating at a first subarea of the plurality of subareas and terminating at a second subarea of the plurality of subareas. The various subareas of the display may or may not be associated with characters or character values, such as numbers for pin code digit entry, or the like. Partitioning of a touchscreen display in accordance with embodiments disclosed herein may be implemented according to any suitable or desirable configuration and/or arrangement of partitions. Furthermore, touchscreen display partitioning may be implemented using touchscreen displays having any size, shape or configuration.

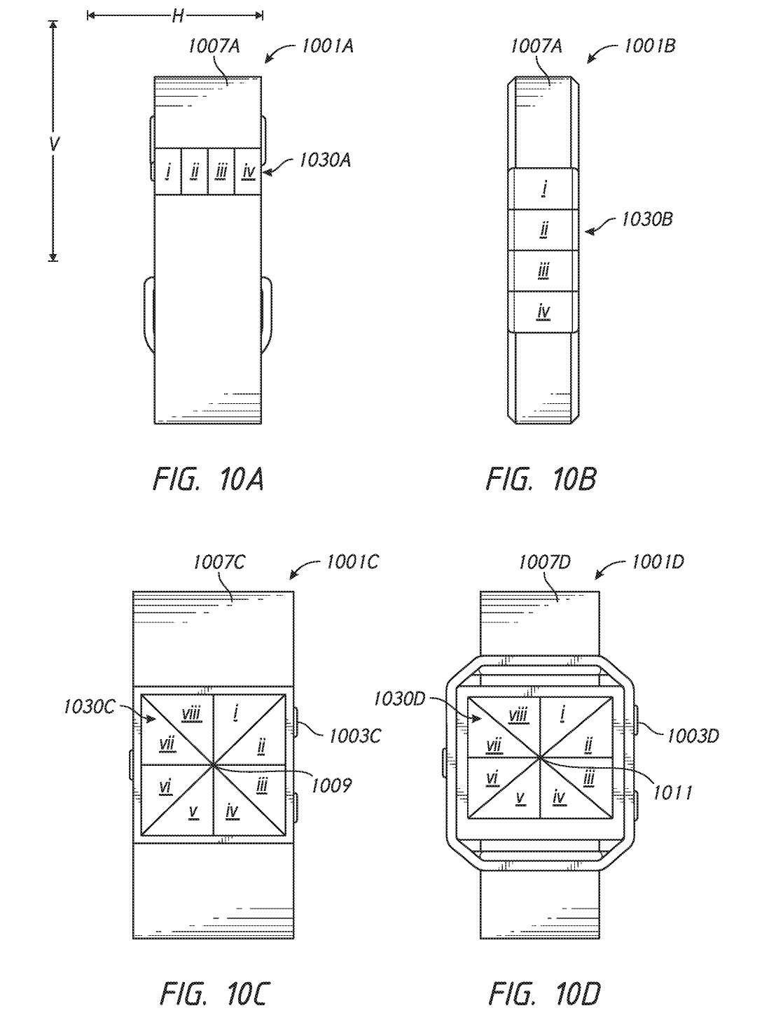

FIGS. 10A-10D illustrate embodiments of wearable computing devices having touchscreen displays functionally and/or visually partitioned into subareas for user input in accordance with one or more embodiments of the present disclosure. The computing devices of FIGS. 10A-10D are illustrated in a generally vertical orientation, represented by the vertical axis V, wherein a horizontal axis is represented as the axis H for discussion purposes.

FIG. 10A illustrates a wearable computing device 1001A having a generally rectangular, horizontally-arranged, display 1030A. The wearable computing device 1001A may further comprise a band component 1007A, which may be used to secure the computing device 1001A to an arm, wrist, or other member of a user. The computing device 1001A includes a generally rectangular-shaped touchscreen display 1030A, which may have a horizontal dimension that is greater than an associated vertical dimension of the display 1030A, as shown. In certain embodiments, the display 1030A may be visually and/or functionally partitioned into a plurality of subareas i-iv, which may be arranges and/or configured in any suitable or desirable manner. For example, as shown, the subareas i-iv may be horizontally-arranged rectangular subareas.

FIG. 10B illustrates a wearable computing device 1001B having a generally rectangular display 1030B. The computing device 1001B includes a generally rectangular-shaped touchscreen display 1030B, which may have a vertical dimension that is greater than an associated horizontal dimension of the display 1030B, as shown. In certain embodiments, the display 1030B may be visually and/or functionally partitioned into a plurality of subareas i-iv, which may be arranges and/or configured in any suitable or desirable manner. For example, as shown, the subareas i-iv may be vertically-arranged rectangular subareas.

FIG. 10C illustrates a front view of a wearable computing device 1001C, comprising a touchscreen display 1030C associated with a computing device. The display 1030C of the computing device 1001C may represent a display having a generally rectangular shape, wherein the display may have a square shape, or alternatively the vertical dimension of the display may be slightly greater than the horizontal dimension thereof. In certain embodiments, the display 1030C may be visually and/or functionally partitioned into a plurality of subareas i-viii, which may be arranges and/or configured in any suitable or desirable manner. For example, as shown, the subareas i-viii may be generally triangular-shaped subareas arranged about a central point 1009.

FIG. 10D illustrates a front view of a wearable computing device 1001D, comprising a touchscreen display 1030D associated with a computing device. The display 1030D of the computing device 1001D may represent a display having a generally rectangular shape, wherein the display may have a square shape, or alternatively the horizontal dimension of the display may be slightly greater than the vertical dimension thereof. In certain embodiments, the display 1030D may be visually and/or functionally partitioned into a plurality of subareas i-viii, which may be arranges and/or configured in any suitable or desirable manner. For example, as shown, the subareas i-viii may be generally triangular-shaped subareas arranged about a central point 1011.

Although each of the devices of FIGS. 10A-10D shows a display having a particular number of subareas, it should be understood that touchscreen displays of any size, shape, or configuration may be partitioned into any number of subareas.

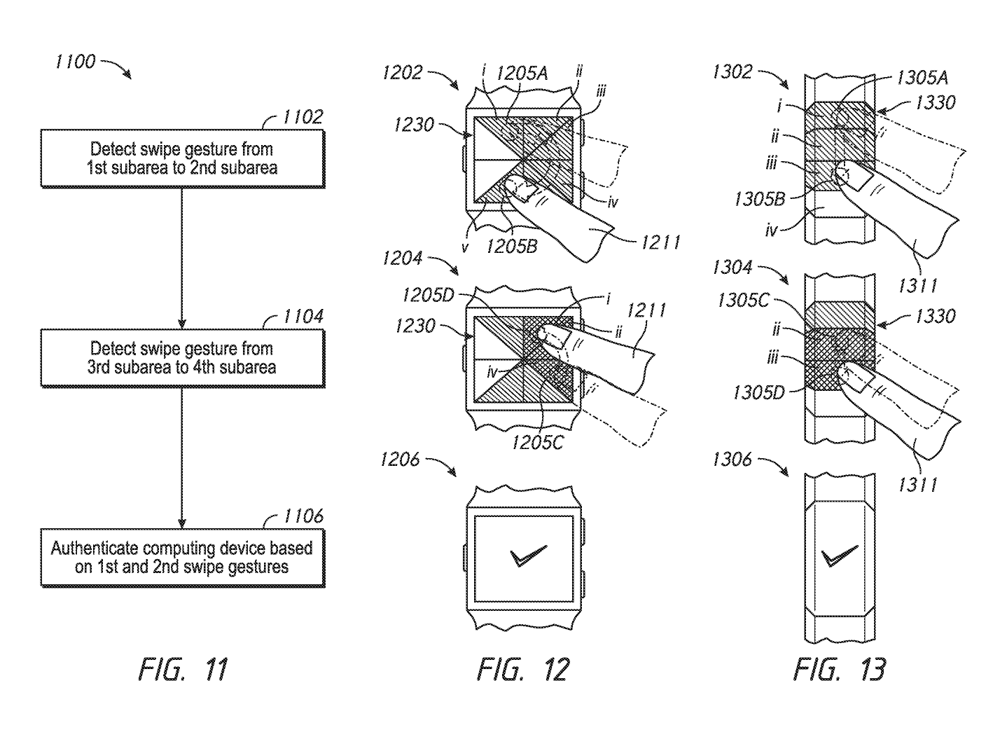

FIG. 11 is a flow diagram illustrating a process 1100 for authenticating a computing device according to one or more embodiments. The process 1100 may be implemented at least in part by a user of the computing device and/or control circuitry of the computing device. FIGS. 12 and 13 provide images of the respective computing devices corresponding to the various steps or stages of the process 1100, as shown. Each of the computing devices of FIGS. 12 and 13 comprises a touchscreen display visually and/or functionally partitioned into a plurality of subareas in accordance with the present disclosure. FIG. 12 illustrates a touchscreen display 1230 having a generally rectangular shape, wherein the subareas of the display have a generally triangular shape, while FIG. 13 illustrates a touchscreen display 1330 that has a generally vertical rectangular shape having generally rectangular subareas. Although certain embodiments are illustrated in FIGS. 12 and 13, it should be understood that the process 1100 may be implemented in connection with touchscreen displays having any suitable or desirable shape and/or configuration of display and/or subareas thereof.

At block 1102, the process 1100 involves detecting a swipe gesture on the touchscreen display of the computing device from a first subarea i to a second subarea (v with respect to FIG. 12 and iii with respect to FIG. 13). For example, in connection with block 1102, the user may touch a first subarea of the display at a first touch point (1205A in FIGS. 12 and 1305A in FIG. 13) and execute a swipe gesture to the second subarea of the display, ending at a second touch point (1205B in FIGS. 12 and 1305B FIG. 13). Control circuitry of the computing device may detect such touch points and/or swipe gestures according to the process 1100.

At block 1104, the process 1100 involves detecting another swipe gesture from a third subarea (iv with respect to FIG. 12 and ii with respect to FIG. 13) to a fourth subarea (i with respect to FIG. 12 and iii with respect to FIG. 13) of the touchscreen display. Each of the third and fourth subareas of the touchscreen display may be the same as one or more of the first and second subareas, or may be distinct therefrom. Detection of the swipe gesture from the third subarea to the fourth subarea may involve detecting the touching of the user's finger (1211 in FIGS. 12 and 1311 in FIG. 13) or other member or tool at a third touch point (1205C in FIGS. 12 and 1305C in FIG. 13), the third touch point being located at least partially with in a third subarea (ivin FIG. 12 and ii in FIG. 13) and dragging of the finger along a swipe gesture path from the third subarea to the fourth touch point (1205D in FIGS. 12 and 1305D in FIG. 13) located at least partially within a fourth subarea (ii in FIG. 12 and iii in FIG. 13). The second swipe gesture may have the same general directionality as the first swipe gesture, or may be in a different direction, such as in a direction substantially opposite to that of the first swipe gesture. For example, with respect FIG. 12, the first swipe gesture may be a rotational swipe gesture in a clockwise direction, whereas the second swipe gesture may be in a counterclockwise direction, or vice versa, or the first and second swipe gestures may both be in either the clockwise direction or the counterclockwise direction. With respect to FIG. 13, for example, the first swipe gesture may be in a generally downward direction, while the second touch gesture may be in a generally upward direction, or vice versa. Alternatively, the first and second swipe gestures may both be in the upward direction or the downward direction. Although FIGS. 12 and 13 provide only two examples of partitioned display screens, it should be understood that the process 1100 may be implemented using touchscreen displays having any size or configuration and/or any arrangement or configuration of partitioned subareas of the display for user input according to the present disclosure.

At block 1106, the process 1100 involves authenticating computing device based on the first and second swipe gestures. For example, authentication may involve providing access to the user to certain applications, data, and/or functionality of the computing device. Although only first and second swipe gestures are illustrated and described in connection with FIGS. 11,12, and 13, the process 1100 may involve or require additional swipe gestures and/or detection thereof in order to authenticate the computing device. For example, in certain embodiments, three or four swipe gestures are executed and/or detected in order to authenticate the computing device.

### Additional Embodiments

Depending on the embodiment, certain acts, events, or functions of any of the processes or algorithms described herein can be performed in a different sequence, may be added, merged, or left out altogether. Thus, in certain embodiments, not all described acts or events are necessary for the practice of the processes. Moreover, in certain embodiments, acts or events may be performed concurrently, e.g., through multi-threaded processing, interrupt processing, or via multiple processors or processor cores, rather than sequentially.

Certain methods and/or processes described herein may be embodied in, and partially or fully automated via, software code modules executed by one or more general and/or special purpose computers. The word “module” refers to logic embodied in hardware and/or firmware, or to a collection of software instructions, possibly having entry and exit points, written in a programming language, such as, for example, C or C++. A software module may be compiled and linked into an executable program, installed in a dynamically linked library, or may be written in an interpreted programming language such as, for example, BASIC, Perl, or Python. It will be appreciated that software modules may be callable from other modules or from themselves, and/or may be invoked in response to detected events or interrupts. Software instructions may be embedded in firmware, such as an erasable programmable read-only memory (EPROM). It will be further appreciated that hardware modules may be comprised of connected logic units, such as gates and flip-flops, and/or may be comprised of programmable units, such as programmable gate arrays, application specific integrated circuits, and/or processors. The modules described herein are preferably implemented as software modules, but may be represented in hardware and/or firmware. Moreover, although in some embodiments a module may be separately compiled, in other embodiments a module may represent a subset of instructions of a separately compiled program, and may not have an interface available to other logical program units.

In certain embodiments, code modules may be implemented and/or stored in any type of computer-readable medium or other computer storage device. In some systems, data (and/or metadata) input to the system, data generated by the system, and/or data used by the system can be stored in any type of computer data repository, such as a relational database and/or flat file system. Any of the systems, methods, and processes described herein may include an interface configured to permit interaction with patients, health care practitioners, administrators, other systems, components, programs, and so forth.

Conditional language used herein, such as, among others, “can,” “could,” “might,” “may,” “e.g.,” and the like, unless specifically stated otherwise, or otherwise understood within the context as used, is intended in its ordinary sense and is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous, are used in their ordinary sense, and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. Conjunctive language such as the phrase “at least one of X, Y and Z,” unless specifically stated otherwise, is understood with the context as used in general to convey that an item, term, element, etc. may be either X, Y or Z. Thus, such conjunctive language is not generally intended to imply that certain embodiments require at least one of X, at least one of Y and at least one of Z to each be present.

Reference throughout this specification to “certain embodiments” or “an embodiment” means that a particular feature, structure or characteristic described in connection with the embodiment is included in at least some embodiments. Thus, appearances of the phrases “in some embodiments” or “in an embodiment” in various places throughout this specification are not necessarily all referring to the same embodiment and may refer to one or more of the same or different embodiments. Furthermore, the particular features, structures or characteristics can be combined in any suitable manner, as would be apparent to one of ordinary skill in the art from this disclosure, in one or more embodiments.

It should be appreciated that in the above description of embodiments, various features are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that any claim require more features than are expressly recited in that claim. Moreover, any components, features, or steps illustrated and/or described in a particular embodiment herein can be applied to or used with any other embodiment(s). Further, no component, feature, step, or group of components, features, or steps are necessary or indispensable for each embodiment. Thus, it is intended that the scope of the inventions herein disclosed and claimed below should not be limited by the particular embodiments described above, but should be determined only by a fair reading of the claims that follow.

What is claimed is:

1. A method of authenticating a computing device
displaying a plurality of subareas on a touchscreen display of a computing device;
detecting a touch contact in a first subarea of the plurality of subareas;
detecting a first swipe gesture from the first subarea to a second subarea of the plurality of subareas;
detecting a first confirmation gesture associated with the first swipe gesture; and
authenticating the computing device based at least in part on the first swipe gesture.

2. The method of claim 1, further comprising altering an appearance of the first subarea, the second subarea, and one or more intervening subareas touched by the first swipe gesture at least partly in response to said detecting the first swipe gesture.

3. The method of claim 1, wherein each of the plurality of subareas of the display is the same size.

4. The method of claim 1, wherein each of the plurality of subareas has at least one acute angle.

5. The method of claim 1, further comprising altering an appearance of the first subarea on the display in response to said detecting the touch contact in the first subarea.

6. The method of claim 1, wherein:
the computing device is a wrist-wearable computing device comprising a band having a longitudinal axis;
the display is a rectangular display having a longitudinal axis that is substantially parallel to the longitudinal axis of the band; and
the plurality of subareas are rectangular subareas stacked along the longitudinal axis of the display.

7. The method of claim 1, wherein the first swipe gesture is an at least partially circular swipe gesture.

8. The method of claim 7, wherein the first swipe gesture is at least partially circular about a center point of the display.

9. The method of claim 1, further comprising:
detecting a touch contact in a third subarea of the plurality of subareas;
detecting a second swipe gesture from the third subarea to a fourth subarea of the plurality of subareas; and
detecting a second confirmation gesture associated with the second swipe gesture;
wherein said authenticating the computing device is based at least in part on the second swipe gesture.

10. The method of claim 9, wherein the first subarea is the same as at least one of the second subarea, the third subarea, and the fourth subarea.

11. The method of claim 9, wherein the first swipe gesture is in a first rotational direction, and the second swipe gesture is in a second rotational direction substantially opposite the first rotational direction.

12. The method of claim 9, wherein the first swipe gesture is in a first direction along a longitudinal axis of the display and the second swipe gesture is in a second direction substantially opposite the first direction along the longitudinal axis of the display.

13. The method of claim 9, wherein the first subarea is different from the third subarea.

14. A wearable computing device comprising:
an electronic touchscreen display; and
control circuitry configured to:
display a plurality of subareas on a touchscreen display of a computing device;
detect a touch contact in a first subarea of the plurality of subareas;
detect a first swipe gesture from the first subarea to a second subarea of the plurality of subareas;
detect a first confirmation gesture associated with the first swipe gesture; and
authenticate the computing device based at least in part on the first swipe gesture.

15. The wearable computing device of claim 14, wherein the control circuitry is further configured to alter an appearance of the first subarea, the second subarea, and one or more intervening subareas touched by the first swipe gesture at least partly in response to said detecting the first swipe gesture.

16. The wearable computing device of claim 14, further comprising a band having a longitudinal axis, wherein the touchscreen display is a rectangular display having a longitudinal axis that is substantially parallel to the longitudinal axis of the band and the plurality of subareas are rectangular subareas stacked along the longitudinal axis of the display.

17. The wearable computing device of claim 14, wherein the each of the plurality of subareas has at least one acute angle.

18. The wearable computing device of claim 14, wherein each of the plurality of subareas of the display is the same size.

19. The wearable computing device of claim 14, wherein the control circuitry is further configured to:
detect a touch contact in a third subarea of the plurality of subareas;
detect a second swipe gesture from the third subarea to a fourth subarea of the plurality of subareas; and
detect a second confirmation gesture associated with the second swipe gesture;
wherein said authenticating the computing device is based at least in part on the second swipe gesture.

20. The wearable computing device of claim 19, wherein the first subarea is different from the third subarea.

21. The wearable computing device of claim 19, wherein the first swipe gesture is in a first direction along a longitudinal axis of the display and the second swipe gesture is in a second direction substantially opposite the first direction along the longitudinal axis of the display.

22. The wearable computing device of claim 19, wherein the first swipe gesture and the second swipe gesture are at least partially circular swipe gestures.

23. The wearable computing device of claim 22, wherein the first swipe gesture is in a first rotational direction, and the second swipe gesture is in a second rotational direction substantially opposite the first rotational direction.

24. A method of entering an authentication code using a computing device, the method comprising:
touching a first subarea of a touchscreen display of a computing device, wherein the display is partitioned into a plurality of subareas including the first subarea;
executing a first swipe gesture from the first subarea to a second subarea of the plurality of subareas of the display;
executing a first confirmation gesture associated with the first swipe gesture;
touching a third subarea of the plurality of subareas of the display;
executing a second swipe gesture from the third subarea to a fourth subarea of the plurality of subareas of the display; and
executing a second confirmation gesture associated with the second swipe gesture.

25. The method of claim 24, wherein executing the first confirmation gesture comprises lifting a finger off of the display.

26. The method of claim 24, wherein said touching the first subarea causes the first subarea to have an altered appearance on the display.
